(19) United States
(12) Patent Application Publication
(10) Pub. No.: US 2015/0147896 A1
(43) Pub. Date: May 28, 2015

(54) ELECTRICAL CONNECTOR

(71) Applicant: LOTES CO., LTD, Keelung (TW)

(72) Inventor: Ted Ju, Keelung (TW)

(73) Assignee: LOTES CO., LTD, Keelung (TW)

(21) Appl. No.: 14/251,326

(22) Filed: Apr. 11, 2014

(30) Foreign Application Priority Data
Nov. 26, 2013 (CN) 201320750530.9

(51) Int. Cl. H01R 12/71

(52) U.S. Cl. CPC H01R 12/718
USPC 439/68

(57) ABSTRACT

An electrical connector includes a circuit board, a chip module, an isolation portion, and at least one liquid metal conductor. Multiple first conducting portions are disposed on the circuit board, and multiple second conducting portions are disposed on the chip module. The second conducting portions correspond to the first conducting portions. The isolation portion is located between the circuit board and the chip module. An upper surface and a lower surface of the isolation portion urge against the chip module and the circuit board respectively. The isolation portion surrounds, joints, and seals the first conducting portion. The at least one liquid metal conductor is correspondingly disposed between the first conducting portion and the second conducting portion, and electrically conducting the circuit board and the chip module. The liquid metal conductor is gallium or gallium alloy.

### CROSS-REFERENCE TO RELATED APPLICATION

This non-provisional application claims priority under 35 U.S.C. §119(a) on Patent Application No. 201320750530.9 filed in P.R. China on Nov. 26, 2013, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates generally to an electrical connector, and more particularly to an ultrathin electrical connector.

### BACKGROUND OF THE INVENTION

Electronic products in the industry are made more and more thinner, and in order to respond to market demands, manufacturers weld a central processing unit (CPU) directly onto a circuit board, so as to reduce the thickness of an electrical connector. This connection manner is adopted through welding, so when the CPU is damaged, it is not easy to replace the CPU, and therefore it is difficult to make repair and upgrade.

Therefore, a heretofore unaddressed need exists in the art to address the aforementioned deficiencies and inadequacies.

### SUMMARY OF THE INVENTION

In one aspect, the present invention is directed to an electrical connector which is ultrathin and in which a CPU can be easily replaced.

In one embodiment, the electrical connector includes a circuit board, a chip module, an isolation portion, and at least one liquid metal conductor. Multiple first conducting portions are disposed on the circuit board. Multiple second conducting portions are disposed on the chip module corresponding to the first conducting portions. The isolation portion is located between the chip module and the circuit board. An upper surface and a lower surface of the isolation portion urges against the chip module and the circuit board respectively. The isolation portion surrounds, joints, and seals the first conducting portion. The at least one liquid metal conductor is correspondingly disposed between the first conducting portion and the second conducting portion, and electrically conducting the circuit board and the chip module. The liquid metal conductor is gallium or gallium alloy.

In one embodiment, surfaces of the isolation portion are disposed with hydrophobic material.

In one embodiment, the isolation portion surrounds, joints, and seals the second conducting portion.

In one embodiment, the second conducting portion is a pin or an elastic sheet.

In one embodiment, the second conducting portion is a tin ball.

In one embodiment, the volume of the liquid metal conductor does not exceed ½ of the volume of the tin ball.

In one embodiment, the gallium alloy is gallium-tin alloy.

In one embodiment, the percentage of tin in the gallium-tin alloy is greater than 30%.

In one embodiment, fillers are disposed in the liquid metal conductor.

In one embodiment, an outer surface of the filler is provided with a material compatible with the liquid metal conductor.

In one embodiment, the material is indium or tin or zinc.

In one embodiment, the filler is an elastomer.

In one embodiment, the elastomer is an elastic sheet or sponge or elastic silica gel.

In one embodiment, the filler is a particle.

In one embodiment, the particle is a metal particle or a non-metal particle.

In one embodiment, the particle is magnetic.

In one embodiment, the first conducting portion contacts directly the second conducting portion to form a contact point, and the liquid metal is wrapped around the contact point.

In one embodiment, a first positioning portion is disposed at the isolation portion and the circuit board, and a second position portion is disposed at the isolation portion and the chip module.

In one embodiment, an elastic material is disposed on an upper surface and a lower surface of the isolation portion.

In another aspect, the present invention is directed to an electrical connector. In one embodiment, the electrical connector includes a circuit board and a chip module. Multiple first conducting portions are disposed on the circuit board. Multiple second conducting portions are disposed on the chip module, and correspond to the multiple first conducting portions. The second conducting portions are tin balls. Solid gallium metal is disposed on the first conducting portions. The tin ball and the gallium metal are pressed to form a gallium-tin alloy, which conducts the circuit board and the chip module.

In one embodiment, an isolation portion is disposed between the circuit board and the chip module.

In one embodiment, a protection layer is disposed between the first conducting portion and the gallium metal. The protection layer is a nickel layer.

In one embodiment, a first positioning portion is disposed at the isolation portion and the circuit board, and a second position portion is disposed at the isolation portion and the chip module.

In one embodiment, the first conducting portion press fits and contacts the second conducting portion, and the gallium-tin alloy is formed around the contact point.

In a further aspect, the present invention is directed to an electrical connector. In one embodiment, the electrical connector includes a chip module and a circuit board. Multiple pins are disposed on the chip module, and multiple contact pads are disposed on the circuit board corresponding to the multiple pins. Liquid metal conductor is disposed between the pins and the contact pads. The liquid metal conductor is gallium or gallium alloy. Adhesive is disposed between the chip module and the circuit board. The chip module and the circuit board are electrically conducted through the liquid metal conductor.

In one embodiment, a height of the adhesive is greater than a height of the pin before a press fitting of the chip module.

In one embodiment, the liquid metal conductor is disposed on the pins.

In one embodiment, the adhesive is disposed on the chip module.

In one embodiment, the adhesive has good thermoplastic feature.

In one embodiment, the adhesive can be solidified by ultraviolet (UV) irradiation.

As compared with the related art, in the electrical connector according to certain embodiments of the present invention, the chip module is directly electrically conducted to the circuit board through the liquid metal conductor, thereby greatly reducing the thickness of the electrical connector. Moreover, when the chip module is damaged, the chip module can also be rapidly and conveniently replaced. Further, the disposed isolation portion can effectively reduce occurrence of short circuit. Furthermore, the filler is disposed in the liquid metal conductor, so the quantity of the liquid metal conductor used in the manufacturing process can be reduced, thus reducing the production cost.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a schematic diagram according to a first embodiment of the present invention.

FIG. 2 is a schematic diagram of FIG. 1 where metal particles are disposed in the liquid metal.

FIG. 3 is a schematic diagram of FIG. 1 where sponge is disposed in the liquid metal.

FIG. 4 is an assembled view of the first embodiment of the present invention.

FIG. 5 is a schematic diagram according to a second embodiment of the present invention.

FIG. 6 is a schematic diagram according to a third embodiment of the present invention.

FIG. 7 is a schematic diagram according to a fourth embodiment of the present invention.

FIG. 8 is a schematic diagram according to a fifth embodiment of the present invention where a chip module is not pressed downward.

FIG. 9 is a schematic diagram of FIG. 8 where the chip module is pressed downward.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

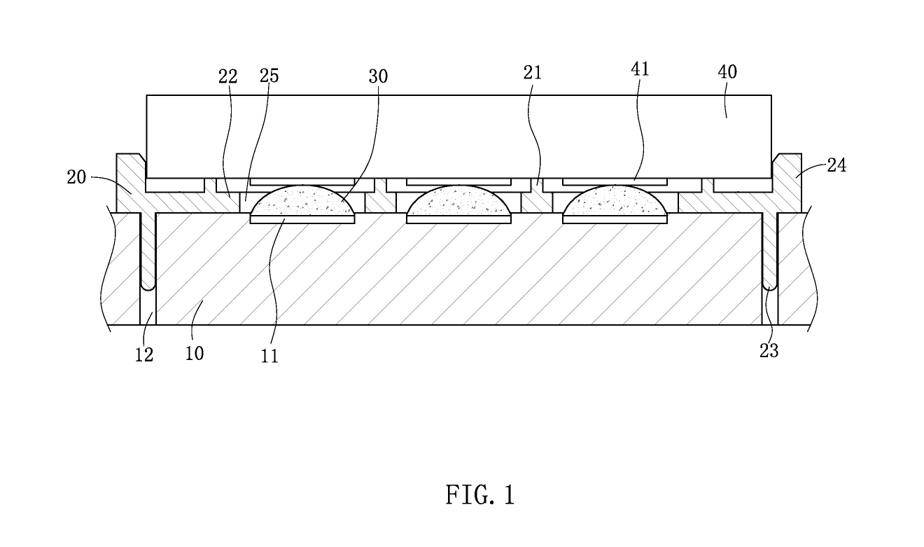

The description will be made as to the embodiments of the present invention in conjunction with the accompanying drawings in FIGS. 1-9. In accordance with the purposes of this invention, as embodied and broadly described herein, this invention, in one aspect, relates to an electrical connector.

As shown in FIGS. 1-4, as a first embodiment of the present invention, an electrical connector includes a circuit board 10 and a chip module 40. The circuit board 10 is electrically connected to the chip module 40 through a liquid metal conductor 30. As shown in FIG. 1, the circuit board 10 has multiple first conducting portions 11 and at least one positioning hole 12. In this embodiment, the number of the positioning holes 12 is two. The two positioning holes 12 are disposed diagonally. The chip module 40 has multiple second conducting portions 41. As shown in FIG. 1, an isolation portion 20 is disposed between the circuit board 10 and the chip module 40. The isolation portion 20 has a base portion 22 and multiple supporting portions 21 protruding from the upper surface of the base portion 22. The base portion 22 has multiple receiving holes 25. Each supporting portion 21 is disposed around the periphery of the receiving hole 25. The supporting portions 21 and the base portion 22 are in a stepped form or scalariform. The isolation portion 20 further includes a first positioning portion 23 and a second positioning portion 24 disposed on the base portion 22. The first positioning portion 23 cooperate with the positioning hole 12 disposed on the circuit board 10, to position the circuit board 10. The second positioning portion 24 is used to guide the chip module 40 to press fit with the circuit board 10. The supporting portions 21 urge against a bottom surface of the chip module 40, and surround and seal the second conducting portions 41. The lower surface of the base portion 22 urges against a top surface of the circuit board 10, and surrounds and seals the first conducting portions 11. The surface of the isolation portion 20 is disposed with hydrophobic material.

The liquid metal conductor 30 is selected from any one of gallium metal, indium-gallium alloy, indium-tin alloy, gallium-tin alloy, and indium-gallium-tin alloy. The melting point of gallium is about 29.76° C., so the gallium metal may directly be used as the liquid metal conductor 30. The melting point of indium is about 156.61° C., the melting point of tin is about 231.93° C., but the melting point of binary or ternary alloy of indium, gallium, and tin may be greatly reduced. The melting points of the foregoing alloys differ according to different proportions. For example, when the proportion of indium-gallium is 24.5:75.5, the melting point of the indium-gallium binary alloy is 15.7° C. When the proportion of indium gallium tin is 20.5:66.5:13.0, the melting point of the indium-gallium-tin ternary alloy is 10.7° C. Therefore, the liquid metal conductor 30 may further be any one of indium-gallium, indium-tin, gallium-tin, and indium-gallium-tin. A user may prepare gallium metal, or alloy of indium, gallium, and tin metal according to a proportion, so that at a normal (room or environmental) temperature, the gallium metal, the indium-gallium alloy, the indium-tin alloy, the gallium-tin alloy and the indium-gallium-tin alloy are in a liquid form. Therefore, the contact area between the metals is large, the impedance is small, and during current transmission, no or little energy is consumed due to the impedance. Thus, stability of current transmission is ensured, and good result of electrical connection is obtained.

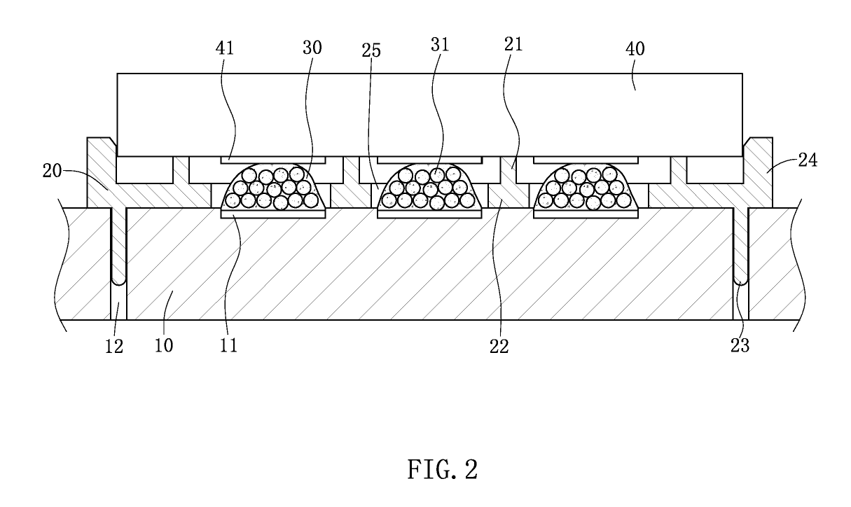

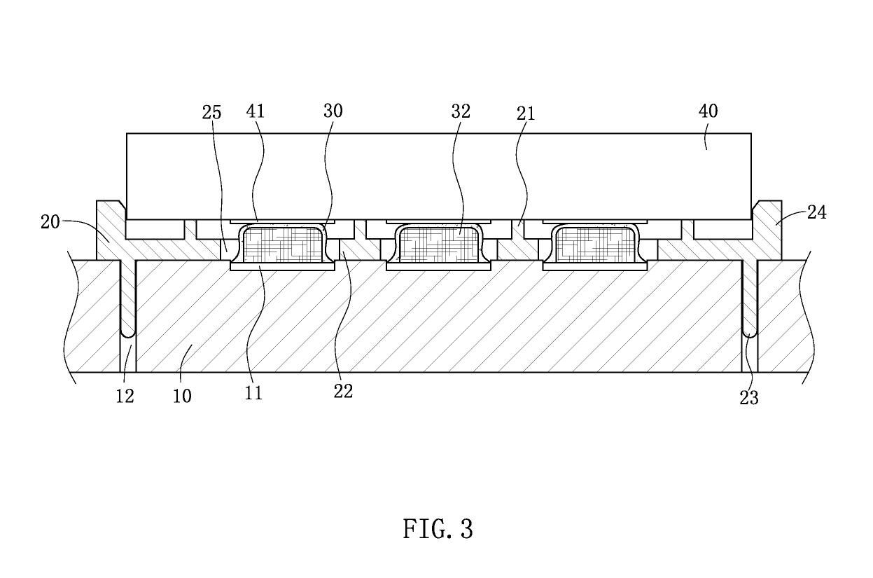

As shown in FIG. 2 and FIG. 3, fillers are disposed in the liquid metal conductor 30. The outer surface of the filler is provided with a material (not shown) compatible with the liquid metal conductor 30, and the material may be indium or tin or zinc. The filler may be a particle 31 or an elastomer (not shown). The particle 31 may be a metal particle, such as a copper ball and a silver ball, or may also be a non-metal particle, such as a plastic ball or a silica gel ball. The particle 31 may further be magnetic. The elastomer may be sponge 32 or an elastic sheet (not shown).

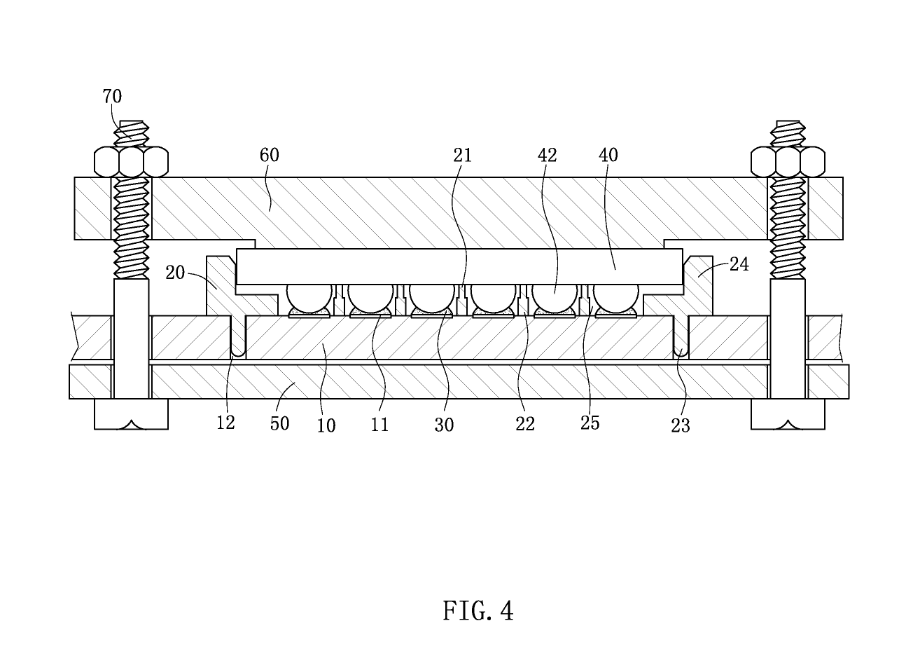

As shown in FIG. 4, a back board 50 is disposed below the circuit board 10, and a pressing plate 60 is disposed above the chip module 40. The pressing plate 60 is fixed to the back board 50 through a fastening apparatus 70. The fastening apparatus 70 and the pressing plate 60 provide the strength for pressing the chip module 40 downward.

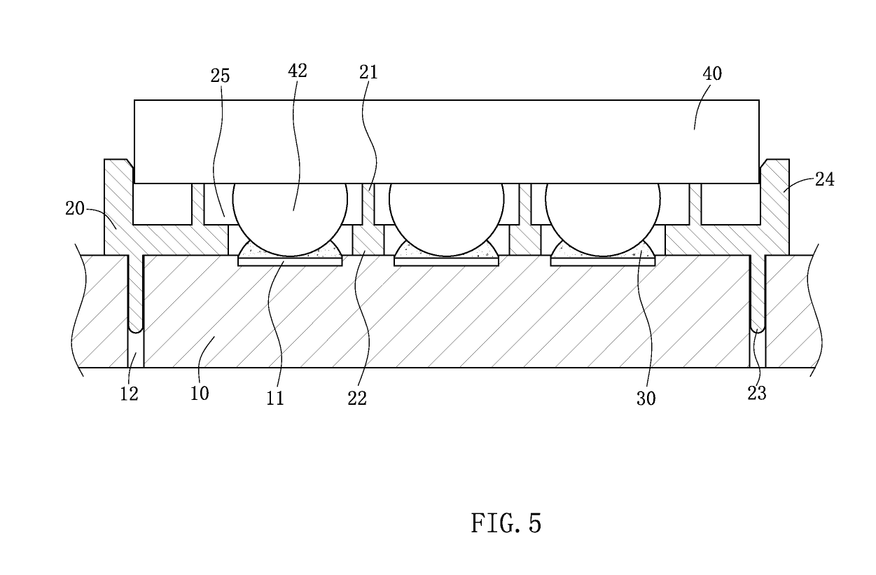

As shown in FIG. 5, a second embodiment of the present invention has similar structures as that of the first embodiment. In the second embodiment, the second conducting portions are tin balls 42. To prevent excessive erosion of the tin balls 42 by the liquid metal conductors 30, the volume of each liquid metal conductor 30 does not exceed half the volume of a corresponding tin ball 42.

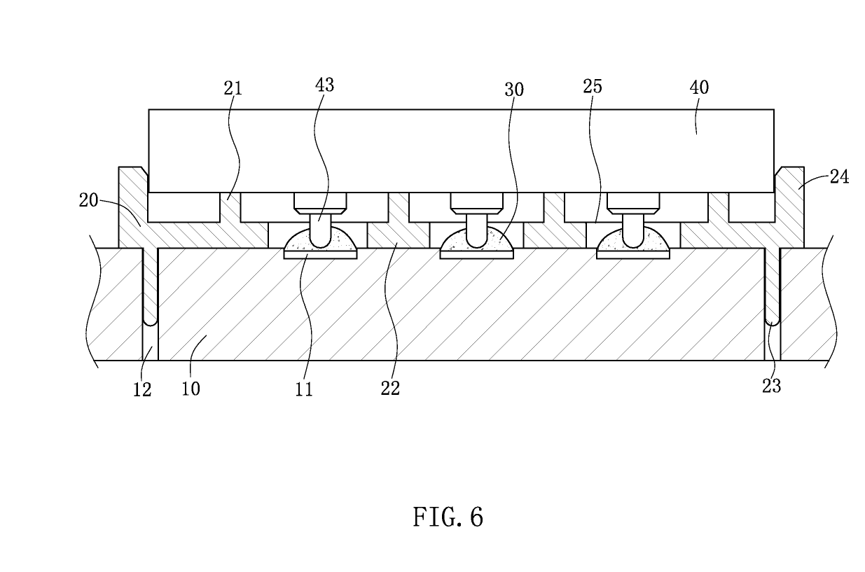

As shown in FIG. 6, a third embodiment of the present invention has similar structures as that of the first embodiment. In the third embodiment, the second conducting portions 41 are pins 43.

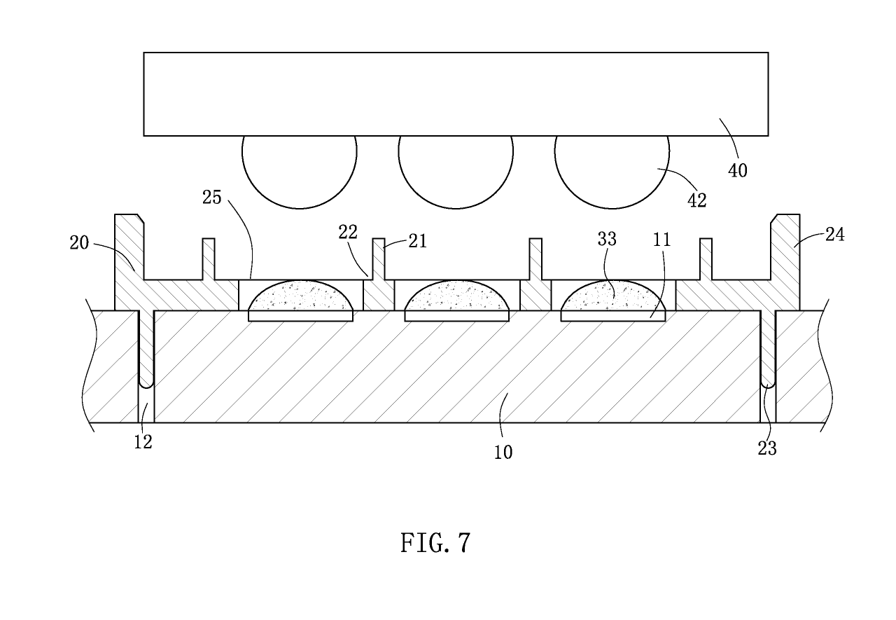

As shown in FIG. 7, a fourth embodiment of the present invention has similar structures as that of the first embodiment. In the fourth embodiment, the second conducting portions 41 are tin balls 42. The first conducting portions 11 are disposed with gallium metal 33. By press fitting of the chip module 40 to the circuit board 10, the tin balls 42 can form gallium-tin alloy (not shown) with the gallium metal 33, which conducts the circuit board 10 and the chip module 40. A protection layer (not shown) is disposed between the first conducting portion 11 and the gallium metal 33, and the protection layer is a nickel layer.

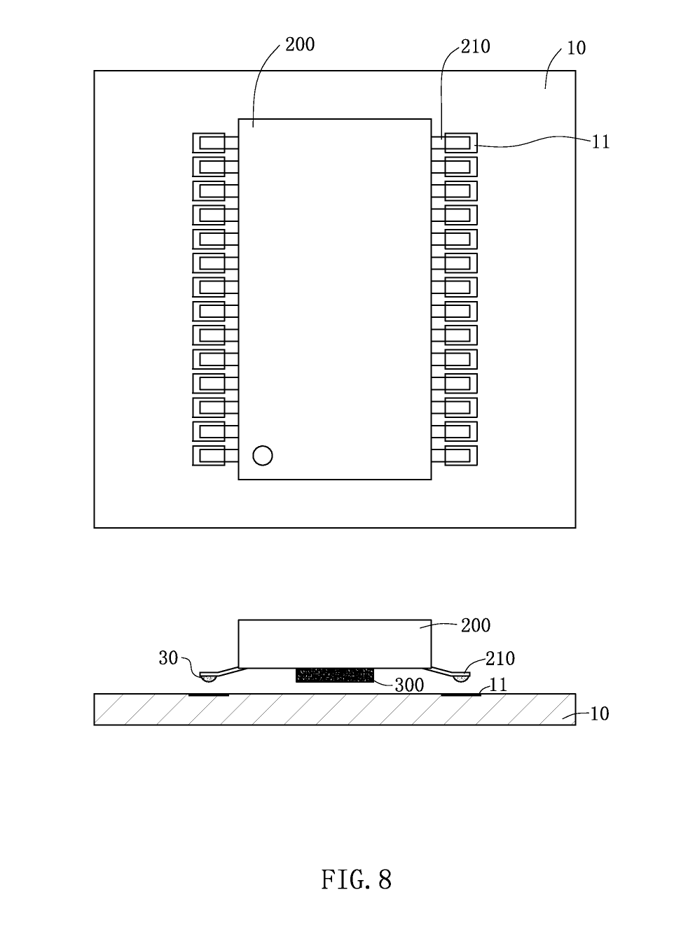

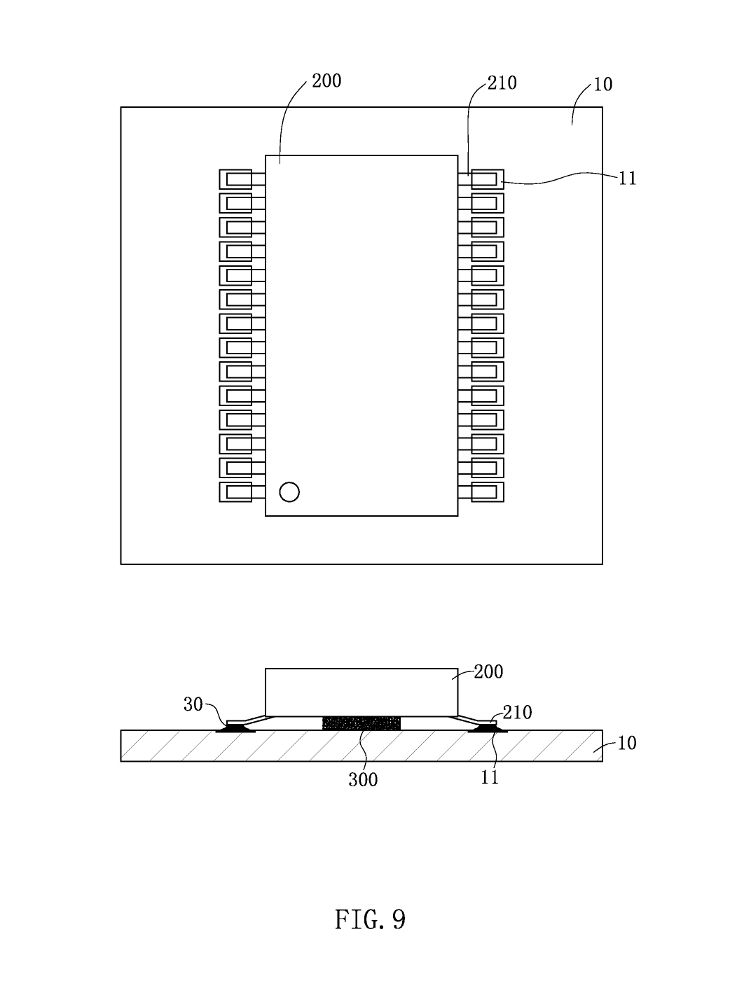

As shown in FIG. 8 and FIG. 9, a fifth embodiment of the present invention has similar structures as that of the first embodiment. In the fifth embodiment, the chip module 200 has multiple pins 210. The circuit board 10 has multiple contact pads 11. The pins 210 are disposed with the liquid metal conductor 30. The liquid metal conductor 30 is gallium or gallium alloy. By press fitting the chip module 200 and the circuit board 10, the pins 210 conducts the contact pads 11 through the liquid metal conductor 30, thus achieving the electrical conduction between the chip module 200 and the circuit board 10. In one embodiment, an adhesive 300 is disposed between the chip module 200 and the circuit board 100. Before the press fitting of the chip module 200, the height of the adhesive 300 is greater than the height of the pins 210. The adhesive 300 has good thermoplastic feature. During assembly, the adhesive 300 can be solidified by UV irradiation. This embodiment can also be achieved by other methods.

The electrical connector according to certain embodiments of the present invention, among other things, has the following beneficial advantages.

(1) In the electrical connector according to certain embodiment of the present invention, the chip module 40 is electrically conducted with the circuit board 10 directly through the liquid metal conductor 30, thereby greatly reducing the thickness of the electrical connector. Moreover, when the chip module 40 is damaged, the chip module 40 can also be rapidly and conveniently replaced.

(2) The isolation portion 20 can further effectively reduce occurrence of short circuit.

(3) By disposing the filler in the liquid metal conductor 30, the fluidity of the liquid metal conductor 30 can be reduced, and short circuit may be prevented from occurring. The height of the liquid metal conductor 30 may be further increased, so that the risk of power failure because of non-contact of an externally connected electronic element (such as a CPU or a chip) or vibration impact may further be reduced.

(4) The filler is disposed in the liquid metal conductor 30, so the quantity of the liquid metal conductor 30 used in the manufacturing process may be reduced, and the production cost may be reduced.

(5) The elastic fillers are disposed in the liquid metal conductor 30, so the contact portion may be elastic, and the risk of power failure because of non-contact of an externally connected electronic element (such as a CPU or a chip) or vibration impact may further be reduced.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, comprising:
a circuit board, having multiple first conducting portions disposed thereon;
a chip module, having multiple second conducting portions disposed thereon, wherein the second conducting portions correspond to the first conducting portions;
an isolation portion disposed between the circuit board and the chip module, wherein an upper surface and a lower surface of the isolation portion urge against the chip module and the circuit board respectively, and the isolation portion surrounds, joints, and seals the first conducting portion; and
at least one liquid metal conductor correspondingly disposed between one of the first conducting portions and a corresponding second conducting portion of the second conducting portions, wherein the at least one liquid metal conductor electrically conducts the circuit board and the chip module, and the at least one liquid metal conductor is gallium or gallium alloy.

2. The electrical connector according to claim 1, wherein surfaces of the isolation portion is disposed with hydrophobic material.

3. The electrical connector according to claim 1, wherein the isolation portion surrounds, joints, and seals the second conducting portion.

4. The electrical connector according to claim 1, wherein each of the second conducting portions is a pin or an elastic sheet.

5. The electrical connector according to claim 1, wherein each of the second conducting portions is a tin ball.

6. The electrical connector according to claim 5, wherein the volume of each liquid metal conductor is equal or less than ½ of the volume of a corresponding tin ball.

7. The electrical connector according to claim 1, wherein the gallium alloy is gallium-tin alloy.

8. The electrical connector according to claim 7, wherein a percentage of tin in the gallium-tin alloy is greater than 30%.

9. The electrical connector according to claim 1, further comprising fillers disposed in the liquid metal conductor.

10. The electrical connector according to claim 9, wherein a surface of the filler is disposed with a material compatible with the liquid metal conductor.

11. The electrical connector according to claim 10, wherein the material is indium, tin, or zinc.

12. The electrical connector according to claim 9, wherein the filler is an elastomer.

13. The electrical connector according to claim 12, wherein the elastomer is an elastic sheet, sponge, or an elastic silica gel.

14. The electrical connector according to claim 9, wherein the filler is a particle.

15. The electrical connector according to claim 14, wherein the particle is a metal particle or a non-metal particle.

16. The electrical connector according to claim 14, wherein the particle is magnetic.

17. The electrical connector according to claim 1, wherein the first conducting portion directly contacts the second conducting portion to form a contact point, and the at least one liquid metal conductor is wrapped around the contact point.

18. The electrical connector according to claim 1, further comprising a first positioning portion disposed between the isolation portion and the circuit board, and a second positioning portion disposed between the isolation portion and the chip module.

19. The electrical connector according to claim 1, where the upper surface and the lower surface of the isolation portion is disposed with an elastic material.

20. An electrical connector, comprising:
a circuit board, having multiple first conducting portions disposed thereon; and
a chip module, having multiple second conducting portions disposed thereon, wherein the second conducting portions correspond to the first conducting portions,
wherein the first conducting portions are disposed with solid gallium, the second conducting portions are tin balls, and the gallium and the tin balls are pressed to form gallium-tin alloy, such that the circuit board and the chip module are conducted through the gallium-tin alloy.

21. The electrical connector according to claim 20, further comprising an isolation portion disposed between the circuit board and the chip module.

22. The electrical connector according to claim 20, further comprising a protection layer disposed between the first conducting portion and the gallium, and the protection layer is a nickel layer.

23. The electrical connector according to claim 20, further comprising a first positioning portion disposed at the isolation portion and the circuit board, and a second positioning portion disposed at the isolation portion and the chip module.

24. The electrical connector according to claim 20, wherein one of the first conducting portions press fits and contacts a corresponding second conducting portion of the second conducting portions to form a contact point, and the gallium-tin alloy is formed around the contact point.

25. An electrical connector, comprising:
a chip module having multiple pins; and
a circuit board having multiple contact pads corresponding to the multiple pins,
wherein liquid metal conductors are disposed between the pins and the contact pads, the liquid metal conductors are gallium or gallium alloy, an adhesive is disposed between the chip module and the circuit board, and the chip module and the circuit board are electrically conducted through the liquid metal conductors.

26. The electrical connector according to claim 25, wherein a height of the adhesive is greater than a height of the pins before press fitting the chip module.

27. The electrical connector according to claim 25, wherein the liquid metal conductors are disposed on the pins.

28. The electrical connector according to claim 25, wherein the adhesive is disposed on the chip module.

29. The electrical connector according to claim 25, wherein the adhesive is thermoplastic.

30. The electrical connector according to claim 25, wherein the adhesive is capable of being solidified by ultraviolet (UV) irradiation.
